(19) United States
(12) Patent Application Publication
(10) Pub. No.: US 2025/0091461 A1
(43) Pub. Date: Mar. 20, 2025

(54) CHARGING CONTROL METHOD FOR MOBILITY APPARATUS AND THE MOBILITY APPARATUS THEREOF

(71) Applicants: HYUNDAI MOTOR COMPANY, SEOUL (KR); KIA CORPORATION, SEOUL (KR)

(72) Inventor: Dae Won Yang, Hwaseong-si (KR)

(73) Assignees: HYUNDAI MOTOR COMPANY, SEOUL (KR); KIA CORPORATION, SEOUL (KR)

(21) Appl. No.: 18/825,560

(22) Filed: Sep. 5, 2024

(30) Foreign Application Priority Data
Sep. 18, 2023 (KR) 10-2023-0123997

(51) Int. Cl. B60L 53/53; B60L 7/10; B60L 53/62; B60L 58/12; B60L 58/18

(52) U.S. Cl. CPC B60L 53/53; B60L 7/10; B60L 53/62; B60L 58/12; B60L 58/18; B60L 2240/545

(57) ABSTRACT

A charging control method for a mobility apparatus including a plurality of first wheels, at least one first drive motor providing a driving power to the plurality of first wheels, a first high-voltage battery providing power to the at least one first drive motor, a first connection mechanism, and a first controller includes when a second high-voltage battery, which is configured to be moved as a first mobility apparatus travels and to supply a charging power to the first high-voltage battery while the first mobility apparatus is traveling and is removeably connected to the first high-voltage battery, is electrically connected to the first high-voltage battery, charging the first high-voltage battery with the second high-voltage battery under settings for a charging efficiency of the first high-voltage battery.

### CROSS REFERENCE TO RELATED APPLICATIONS

This application claims the benefit of Korean Patent Application No. 10-2023-0123997, filed on Sep. 18, 2023, which is hereby incorporated by reference as if fully set forth herein.

### BACKGROUND

### Technical Field

The present disclosure relates to a charging control method for a mobility apparatus and the mobility apparatus thereof.

### Discussion of Related Art

A mobility apparatus includes an electric vehicle.

Generally, the electric vehicle may drive as its wheels are driven by a driving power of a drive motor.

In addition, generally, a high-voltage battery may be fixedly mounted on the vehicle to supply power to the drive motor.

The drive motor may be an alternating current (AC) motor and may thus require an inverter between the battery and the drive motor.

When the battery of the electric vehicle requires charging according to its state of charge, i.e., SoC, it may be charged by receiving external power through an on-board charger (OBC).

In this case, a charging time may be determined based on a charging method, which is broadly divided into slow charging and fast charging.

A driving range (or distance) per charging has been improved greatly in recent years by the continuously ongoing research and development on batteries.

However, a battery fixedly provided in an electric vehicle may not suffice, and there is thus a need for an alternative.

### SUMMARY

The present disclosure provides solutions to the preceding problems arising from typical technologies.

The present disclosure provides a new concept of technology using a second high-voltage battery that may be added to and separated from a power system as needed in addition to a first high-voltage battery previously installed in a mobility apparatus.

An object of the present disclosure is to increase a driving distance of a mobility apparatus equipped with a first high-voltage battery by charging the first high-voltage battery using a second high-voltage battery while the mobility apparatus is traveling.

Another object of the present disclosure is to further increase a driving distance of a mobility apparatus by charging a first high-voltage battery using a second high-voltage battery based on charging efficiency.

To solve the preceding technical problems, according to at least one embodiment of the present disclosure, there is provided a charging control method for a mobility apparatus including a plurality of first wheels, at least one first drive motor providing a driving power to the plurality of first wheels, a first high-voltage battery providing power to the at least one first drive motor, a first connection mechanism, and a first controller, the charging control method including: charging the first high-voltage battery with a second high-voltage battery according to a setting for a charging efficiency of the first high-voltage battery, wherein the second high-voltage battery is configured to be separably or removeably connected to the first high-voltage battery to supply charging power to the first high-voltage battery while the mobility apparatus is traveling.

In at least one embodiment of the present disclosure, the setting may include a determination of whether a state of charge (SoC) of the first high-voltage battery is within a set range.

In at least one embodiment of the present disclosure, the setting may include a charging current determined with respect to the charging efficiency based on a state of the first high-voltage battery.

In at least one embodiment of the present disclosure, the state of the first high-voltage battery may include an SoC and a temperature of the first high-voltage battery.

In at least one embodiment of the present disclosure, the state of the first high-voltage battery may include an SoC and a temperature of the first high-voltage battery.

In at least one embodiment of the present disclosure, the charging current may be determined based further on a driver demand power.

In at least one embodiment of the present disclosure, when the driver demand power is less than an available power of the second high-voltage battery, the charging current may be determined based on the driver demand power and an optimal charging efficiency power according to the SoC and temperature of the first high-voltage battery.

In at least one embodiment of the present disclosure, when the driver demand power is less than zero (0), the charging current may be determined based on the optimal charging efficiency power according to the SoC and temperature of the first high-voltage battery and a regenerative braking power.

In at least one embodiment of the present disclosure, when the optimal charging efficiency power is greater than the regenerative braking power, the charging current may be determined such that a power obtained by subtracting the regenerative braking power from the optimal charging efficiency power is output, and when the optimal charging efficiency power is less than or equal to the regenerative braking power, the charging current may be determined to be 0.

In at least one embodiment of the present disclosure, when the driver demand power is greater than the available power of the second high-voltage battery, the charging current may be determined such that a maximum power is output from the second high-voltage battery.

In at least one embodiment of the present disclosure, when an SoC of the first high-voltage battery is greater than a set first SoC, and a driving distance to a destination is greater than a combined remaining driving distance of the first high-voltage battery and the second high-voltage battery, the charging may include receiving an optimal efficiency charging mode selected by a driver.

To solve the preceding technical problems, according to at least one embodiment of the present disclosure, there is provided a mobility apparatus including a plurality of first wheels, at least one first drive motor providing a driving power to the plurality of first wheels, a first high-voltage battery providing power to the at least one first drive motor, a first connection mechanism, and a first controller. When a second high-voltage battery, which is configured to be moved together with a first mobility apparatus as the first mobility apparatus travels and to supply a charging power to the first high-voltage battery while the first mobility apparatus is traveling and is separably connected to the first high-voltage battery, is electrically connected to the first high-voltage battery, the first controller may be configured to charge the first high-voltage battery with the second high-voltage battery according to a setting for a charging efficiency of the first high-voltage battery.

In at least one embodiment of the present disclosure, the setting may include a determination of whether an SoC of the first high-voltage battery is within a set range.

In at least one embodiment of the present disclosure, the setting may include a charging current determined with respect to the charging efficiency based on a state of the first high-voltage battery.

In at least one embodiment of the present disclosure, the state of the first high-voltage battery may include an SoC and a temperature of the first high-voltage battery.

In at least one embodiment of the present disclosure, the charging current may be determined based further on a driver demand power.

In at least one embodiment of the present disclosure, when the driver demand power is less than an available power of the second high-voltage battery, the charging current may be determined based on the driver demand power and an optimal charging efficiency power according to the SoC and temperature of the first high-voltage battery.

In at least one embodiment of the present disclosure, when the driver demand power is less than 0, the charging current may be determined based on a charging power determined according to the SoC and temperature of the first high-voltage battery and a regenerative braking power.

In at least one embodiment of the present disclosure, when the charging power is greater than the regenerative braking power, the charging current may be determined such that a power obtained by subtracting the regenerative braking power from the charging power is output, and when the charging power is less than or equal to the regenerative braking power, the charging current may be determined to be 0.

In at least one embodiment of the present disclosure, when the driver demand power is greater than or equal to the available power of the second high-voltage battery, the charging current may be determined such that a maximum power is output from the second high-voltage battery.

In at least one embodiment of the present disclosure, the charging may include, when the SoC of the first high-voltage battery is greater than a set first SoC, and a driving distance to a destination is greater than a combined remaining driving distance of the first high-voltage battery and the second high-voltage battery, receiving an optimal efficiency charging mode selected by a driver.

According to embodiments of the present disclosure described herein, a driving distance of a mobility apparatus may be increased by adding or separating a second high-voltage battery to and from a power system.

According to embodiments of the present disclosure described herein, a driving distance of a mobility apparatus may be further increased by charging a first high-voltage battery using a second high-voltage battery based on a charging efficiency.

### BRIEF DESCRIPTION OF THE FIGURES

FIG. 1 illustrates a power system of a first mobility apparatus according to an embodiment of the present disclosure.

FIG. 2 illustrates a connection between a first mobility apparatus and a second mobility apparatus according to an embodiment of the present disclosure.

FIG. 3 illustrates an information exchange between a first controller and a second controller according to an embodiment of the present disclosure.

FIG. 4 illustrates a state of charge (SoC) range with high charging/discharging efficiency for a first high-voltage battery according to an embodiment of the present disclosure.

FIG. 5 illustrates an example current map of high-efficiency charging currents according to an SoC and temperature of a first high-voltage battery according to an embodiment of the present disclosure.

FIG. 6 illustrates a control process according to an embodiment of the present disclosure.

FIG. 7 illustrates the charging of a first high-voltage battery for each interval during driving of a mobility apparatus, and SoC states of the first high-voltage battery and a second high-voltage battery according to an embodiment of the present disclosure.

### DETAILED DESCRIPTION

Hereinafter, embodiments of the present disclosure will be described in detail with reference to the accompanying drawings. The embodiments are not construed as limited to the disclosure and should be understood to include all changes, equivalents, and replacements within the idea and the technical scope of the disclosure.

The terms “module,” “unit,” and/or “-er/or” for referring to elements are assigned and used interchangeably in consideration of the convenience of description, and thus the terms per se do not necessarily have different meanings or functions. The terms “module,” “unit,” and/or “-er/or” do not necessarily require physical separation.

Although terms including ordinal numbers, such as “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it is to be understood that another element may be present therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit” or “control unit” is merely a widely used term for naming a controller that controls a specific vehicle function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, decision, and the like that are necessary for controlling a function assigned thereto.

Meanwhile, a processor may include a semiconductor integrated circuit and/or electronic devices that perform at least one or more of comparison, determination, computation, operations, and decision to achieve programmed functions. The processor may be, for example, any one or a combination of a computer, a microprocessor, a central processing unit (CPU), an application-specific integrated circuit (ASIC), and an electronic circuit (e.g., circuitry and logic circuits).

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, embodiments of the present disclosure will be described in detail with reference to the accompanying drawings.

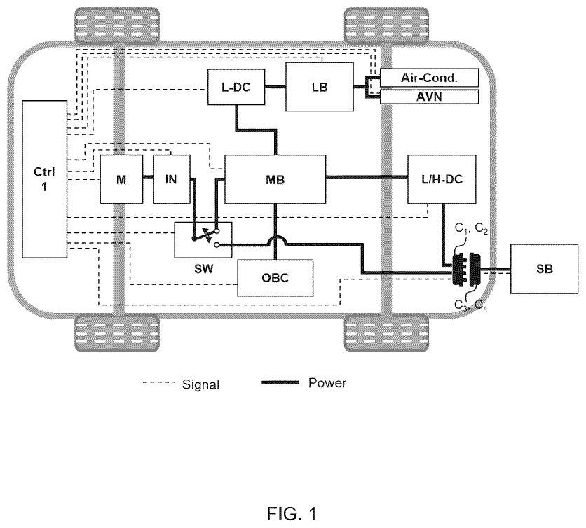

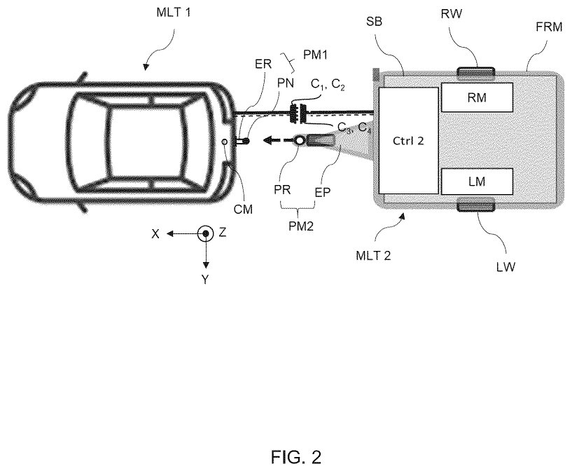

FIG. 1 conceptually illustrates a power system of a first mobility apparatus MLT1 according to an embodiment of the present disclosure, and FIG. 2 illustrates how a second mobility apparatus MLT2 is connected to the first mobility apparatus MLT1.

Referring to FIGS. 1 and 2, respective structures of the first mobility apparatus MLT1 and the second mobility apparatus MLT2 will be described according to an embodiment of the present disclosure.

As shown in FIG. 1, the first mobility apparatus MLT1 may be, for example, an electric vehicle, and include a first drive motor M, an inverter IN, a first high-voltage battery (or a main battery, MB), an on-board charger (OBC), a first direct current to direct current (DC/DC) converter L-DC, a low-voltage battery LB, an air-conditioning device Air-cond that operates with low voltage, an audio video navigation (AVN) system, a second DC/DC converter L/H-DC, a switch SW, and a first controller Ctrl1.

The first drive motor M may provide a driving power to the wheels of the vehicle and may be, for example, an alternating current (AC) motor.

The inverter IN may convert, into AC power, direct current (DC) power to be supplied to the first drive motor M.

The first high-voltage battery MB may be fixedly installed in the body of the first mobility apparatus MLT1, for example, under the cabin floor.

The first high-voltage battery MB may supply electric power to the first drive motor M, as a main function, and may be charged by the OBC.

In addition, the first high-voltage battery MB may be connected to the low-voltage battery LB through the first DC/DC converter L-DC to charge the low-voltage battery LB.

To charge the low-voltage battery LB, the first DC/DC converter L-DC may be a step-down DC/DC converter (e.g., a low-voltage DC/DC converter (LDC)).

The low-voltage battery LB may be, for example, a 12V or 24V battery, and may supply electric power to electrical devices in the vehicle, such as, the air-conditioning device and the AVN system, which operate with low voltage.

A second high-voltage battery SB shown in FIG. 1 may be installed in the second mobility apparatus MLT2, which is to be described below. However, examples are not necessarily limited thereto. For example, the second high-voltage battery SB may be removably installed on the first mobility apparatus MLT1.

The second high-voltage battery SB may be additionally, electrically, and separably connected to the power system of the vehicle including the first high-voltage battery MB, by a wired method (or a wireless method within a possible range), i.e., in a manner that the absence of the second high-voltage battery SB does not affect the operations (e.g., supplying power to electronic units, a drive motor, etc.) of the power system.

The second high-voltage battery SB may also be referred to as a replaceable battery, an auxiliary battery, an extended battery, or a second or secondary battery, but this notation is provided only to differentiate it from the first high-voltage battery MB. That is, the notation or name may not limit the functions, features, mechanical/electrical/chemical structures of its own or related to relationships with other objects (e.g., the first high-voltage battery MB, a host vehicle, etc.), battery type (e.g., packaging, anode/cathode/separator material, etc.), charging type, and the like of the second high-voltage battery SB.

The second high-voltage battery SB may be communicatively connected to the first controller Ctrl1 of the first mobility apparatus MLT1 or a battery management system (BMS) of the first high-voltage battery MB described below, by wire or wirelessly. This may enable the transmission of various sensing information related to a state of charge (SOC) and physical/electrical/chemical states (e.g., voltage, current, temperature, etc.) of the second high-voltage battery SB to the first controller Ctrl1. However, examples are not necessarily limited thereto, and the information associated with the second high-voltage battery SB may also be transmitted to the first controller Ctrl1 through a second controller Ctrl2 of the second mobility apparatus MLT2 described below.

In this embodiment, a high-voltage battery applied to the first high-voltage battery MB and the second high-voltage battery SB may include a plurality of battery cells (not shown) that output a unit voltage within a range of 2.7 to 4.2V, for example. For example, a set number of battery cells may be connected in series/parallel to each other to form a single module. In addition, the high-voltage battery may be provided in a packaged form in which one or more battery modules are connected in series/parallel to each other to form a single battery package such that the high-voltage battery outputs a desired output voltage, for example, approximately 400V, 800V, or several kV.

The first high-voltage battery MB and the second high-voltage battery SB may each include a BMS.

The BMS may include a battery management unit (BMU), a cell monitoring unit (CMU), and a battery junction box (BJB).

The BMS may perform a cell balancing function for ensuring the performance of the entire battery pack by maintaining a constant voltage at each cell, an SoC function for calculating the capacity of the entire battery system, and other functions such as battery cooling, charging, discharging control, and the like.

The BMU may receive information about all the cells from the CMU and perform the functions of the BMS based on the received information.

The BMU may include, for example, two microcontroller units (MCUs) each including one controller area network (CAN) communication port. It may also include a CAN interface for communicating with a vehicle controller, which is an upper-level device of the BMS, and a CAN interface for collecting information from the CMU, which is a lower-level device thereof.

The CMU may be directly attached to a battery cell to sense voltage, current, temperature, and the like. The CMU may simply perform sensing without performing calculations related to BMS algorithms. A plurality of battery cells may be connected to one CMU, and information of each of the cells may be transmitted to the BMU through a CAN interface.

The BJB may be a pack-level sensing mechanism of the BMS and a connection medium between the high-voltage battery and a drive system (e.g., a drivetrain). It may measure and record a battery voltage and a current flowing into and out of a battery to calculate an accurate SoC. The BJB may also perform safety-critical functions such as insulation monitoring, in addition to overcurrent detection.

The second high-voltage battery SB may be a battery with a lower voltage than that of the first high-voltage battery MB and, in this case, the second DC/DC converter L/H-DC may be a step-up DC/DC converter. On the contrary, the second high-voltage battery SB may also be a battery with a higher voltage than that of the first high-voltage battery MB and, in this case, the second DC/DC converter L/H-DC may be a step-down DC/DC converter.

In this embodiment, the second DC/DC converter L/H-DC may be included as a built-in in the first mobility apparatus MLT1 in the power system but is not limited thereto. For example, unlike this embodiment, the second DC/DC converter L/H-DC may be provided as a separate component and may be additionally and separably connected to the power system.

In this embodiment, for the separable electrical connection of the second high-voltage battery SB to the power system, the power system of the first mobility apparatus MLT1 may include first and second connectors C1 and C2, and the second high-voltage battery SB may include third and fourth connectors C3 and C4.

For example, the first and second connectors C1 and C2 may be one integrated connector, and the third and fourth connectors C3 and C4 may also be one integrated connector.

The first connector C1 may be connected to the second DC/DC converter L/H-DC, and the second connector C2 may be connected to the switch SW.

Although not shown, a signal transmission connector may also be added to transmit various sensing and state information of the second high-voltage battery SB to the controller.

The switch SW may be fixedly electrically connected to the inverter IN and may be switched on or off between the first high-voltage battery MB and the second connector C2 to electrically connect the inverter IN and the first high-voltage battery MB or electrically connect the inverter IN and the second high-voltage battery SB.

In this embodiment, the first high-voltage battery MB may be connected to the inverter IN through the switch SW but is not necessarily limited thereto, and the first high-voltage battery MB may be connected directly to the inverter IN without the switch SW. In this case, the second connector C2 and the fourth connector C4 of the second high-voltage battery SB may not be required.

In this embodiment, the first controller Ctrl1 may be an uppermost-level vehicle controller that controls all the electrical devices of the first mobility apparatus MLT1 but is not necessarily limited thereto. That is, for example, the first controller Ctrl1 shown in FIG. 1 may be a power controller, which is a lower-level controller of the vehicle controller.

In addition, as described above, the first controller Ctrl1 may include a computer-readable recording medium that stores an operating system (OS), logic commands, input/output information, and the like, and at least one processor that reads what is stored in the recording medium to perform determinations, calculations, decisions, selections, and the like required to control the functions.

The second high-voltage battery SB shown in FIG. 1 may be installed in the second mobility apparatus MLT2 as shown in FIG. 2.

The second mobility apparatus MLT2 may include a frame FRM, a second left wheel LW installed on the left side of the frame FRM, a second right wheel RW installed on the right side of the frame FRM, a second left drive motor LM configured to provide a driving power to the second left wheel LW, a second right drive motor RM configured to provide a driving power to the second right wheel RW, and a second controller Ctrl2.

The second high-voltage battery SB may be fixedly installed in the second mobility apparatus MLT2 but is not necessarily limited thereto. That is, the second high-voltage battery SB may be removably installed in the second mobility apparatus MLT2. Thus, when fully discharged in its SoC state, the second high-voltage battery SB mounted on the frame FRM may be removed and replaced with a new second high-voltage battery SB fully charged in its SoC state.

When the second high-voltage battery SB is fixedly installed in the second mobility apparatus MLT2, the second mobility apparatus MLT2 may include a charging connector for charging the second high-voltage battery SB.

The frame FRM may form the exterior of the second mobility apparatus MLT2 and serve to house other components.

The frame FRM may include a second pivot mechanism PM2 as a second connection mechanism, and the second pivot mechanism PM2 may be separably and pivotally connected to a first pivot mechanism PM1, which is a first connection mechanism fixed to the vehicle body of the first mobility apparatus MLT1.

For example, the first pivot mechanism PMI may include an extension rod ER extending rearward from the vehicle body of the first mobility apparatus MLT1 and a pivot pin PN protruding upward from an end of the extension rod ER.

The second pivot mechanism PM2 may include a triangular extension portion EP protruding forward from the frame FRM of the second mobility apparatus MLT2 and a pivot ring PR into which the pivot pin PN is rotatably inserted from an end of the extension portion EP.

The pivot pin PN may be limited in its linear movement while inserted in the pivot ring PR and may only rotate about a Z-axis direction as shown in FIG. 2. Accordingly, while in the pivotally connected state, the second mobility apparatus MLT2 may be limited in its linear movement about a pivot connection point with respect to the first mobility apparatus MLT1 and may only rotate about a Z axis.

When driving in a forward direction, i.e., in an X-axis direction, the first mobility apparatus MLT1 and the second mobility apparatus MLT2 may maintain their linearity, without separate steering control for the second mobility apparatus MLT2.

In this embodiment, the first and second connection mechanisms may each include a pivot mechanism but are not necessarily limited thereto. For example, the first and second connection mechanisms may be known mechanisms that implement a non-rotational connection with respect to the Z axis.

The rotation axis of the second left drive motor LM may be connected to the second left wheel LW, through which the second left drive motor LM may provide a driving power to the second left wheel LW.

In addition, the rotation axis of the second right drive motor RM may be connected to the second right wheel RW, through which the second right drive motor RM may provide a driving power to the second right wheel RW.

Since the second left wheel LW and the second right wheel RW are respectively connected to the second left drive motor LM and the second right drive motor RM, they may be driven independently of each other.

The second left drive motor LM and the second right drive motor RM may each be driven in the forward and reverse directions, and the second mobility apparatus MLT2 may travel forward when they are driven in the forward direction and travel backward when they are driven in the reverse direction.

For example, the second left drive motor LM and the second right drive motor RM may each be implemented as an in-wheel drive system in which a drive motor is installed within a wheel, but are not necessarily limited thereto.

In addition, unlike this embodiment, the left and right sides of the second mobility apparatus MLT2 are not driven independently, but the power of a single common motor may be divided into the second left wheel LW and the second right wheel RW and the divided power may be transferred respectively. To this end, a common second drive motor and a differential gear between the second left wheel LW and the second right wheel RW may be provided. That is, the power of the common second drive motor may be distributed by the differential gear into the second left wheel LW and the second right wheel RW. In this case, a torque vectoring means may be added to distribute torque between the second left wheel LW and the second right wheel RW.

As shown in FIG. 2, the second controller Ctrl2 may control the second left drive motor LM and the second right drive motor RM to allow the second mobility apparatus MLT2 to travel in the forward and reverse directions. In addition, when the second mobility apparatus MLT2 needs to steer, the second controller Ctrl2 may change a travel direction of the second mobility apparatus MLT2 by controlling the torque or the number of revolutions of each of the second left drive motor LM and the second right drive motor RM. That is, controlling independently the driving of the second left drive motor LM and the second right drive motor RM may enable the steering of the second mobility apparatus MLT2 without a separate steering device.

In addition, as described above, a wired or wireless communication means may be included to transfer information between the connectors of FIG. 1 and the first mobility apparatus MLT1 and the second mobility apparatus MLT2.

In this embodiment, the first controller Ctrl1 or the second controller Ctrl2 may each include a memory and a processor. The memory may store therein computer instructions for performing the functions of a corresponding controller, and the processor may perform the functions by loading the instructions from the memory and executing them.

The memory may include, as non-limiting examples, at least one of a hard disk drive (HDD), a solid-state drive (SDD), a silicon disk drive (SDD), a read-only memory (ROM), a random-access memory (RAM), a compact disc ROM (CD-ROM), a magnetic tape, a floppy disk, and an optical data storage device.

The processor may include, as non-limiting examples, at least one of a computer, a microprocessor, a central processing unit (CPU), an application-specific integrated circuit (ASIC), an electric circuit, and a logic circuit.

As the first and second connectors C1 and C2 of the first mobility apparatus MLT1 and the third and fourth connectors C3 and C4 of the second mobility apparatus MLT2 are connected, and the signal transmission connector is connected, the first mobility apparatus MLT1 and the second mobility apparatus MLT2, i.e., the first controller Ctrl1 and the second controller Ctrl2, may enter a state in which they are communicable with each other.

When the first mobility apparatus MLT1 starts traveling forward while the first mobility apparatus MLT1 and the second mobility apparatus MLT2 are in mechanical and electrical connection, the second controller Ctrl2 may control the second left drive motor LM and the second right drive motor RM based on a signal transmitted from the first connector C1 based on the traveling speed to allow the second mobility apparatus MLT2 to travel forward straightly.

In this case, some or all of information including the speed, gear position, steering angle, accelerator pedal sensor (APS) information, and brake pedal sensor (BPS) information of the first mobility apparatus MLT1 may be transmitted to the second mobility apparatus MLT2.

For example, the second controller Ctrl2 of the second mobility apparatus MLT2 may use some or all of the information including the speed, gear position, APS information, and BPS information of the first mobility apparatus MLT1 to determine whether the first mobility apparatus MLT1 is in a forward traveling state or a reverse traveling state. However, examples are not limited thereto, and the second controller Ctrl2 of the second mobility apparatus MLT2 may receive information about whether the first mobility apparatus MLT1 is traveling in a forward or reverse direction directly from the first controller Ctrl1.

When the first mobility apparatus MLT1 is traveling in the forward direction, the second controller Ctrl2 may drive the second left drive motor LM and the second right drive motor RM in the forward direction such that the second mobility apparatus MLT2 travels forward straightly. In addition, when the first mobility apparatus MLT1 is traveling in the reverse direction, the second controller Ctrl2 may drive the second left drive motor LM and the second right drive motor RM in the reverse direction such that the second mobility apparatus MLT2 travels backward.

In addition, the second controller Ctrl2 may determine a steering state based on the steering angle information of the first mobility apparatus MLT1 and perform the steering of the second mobility apparatus MLT2 accordingly.

The second mobility apparatus MLT2 may not include a separate steering device such as a steering wheel, a steering rack, and the like, but may still perform the steering by controlling the torque of the second left drive motor LM and the second right drive motor RM.

That is, the second controller Ctrl2 may calculate a driving torque for driving and a steering torque for steering for each of the second left drive motor LM and the second right drive motor RM, and use the calculated torque to control.

For example, to achieve the steering of the second mobility apparatus MLT2, the steering torque values of the second left drive motor LM and the second right drive motor RM according to the steering angle of the first mobility apparatus MLT1 may be included in a lookup table or a calculation program.

When traveling straight forward, the second mobility apparatus MLT2 may be controlled not to have the speed that is greater than the speed of the first mobility apparatus MLT1. Through this, a pivotal connection between the first mobility apparatus MLT1 and the second mobility apparatus MLT2 may be maintained within a predetermined pivot angle range. For example, when the speed of the second mobility apparatus MLT2 is controlled not to be greater than the speed of the first mobility apparatus MLT1 during the straight forward traveling, a pivot angle of the second mobility apparatus MLT2 with respect to the first mobility apparatus MLT1 at the pivot connection point may be maintained to be zero (0) degrees (which indicates an angle at which the first mobility apparatus MLT1 and the second mobility apparatus MLT2 are in a straight line).

During the forward traveling, the second mobility apparatus MLT2 may be controlled to follow the first mobility apparatus MLT1, which may enable smooth connected driving of multiple mobilities.

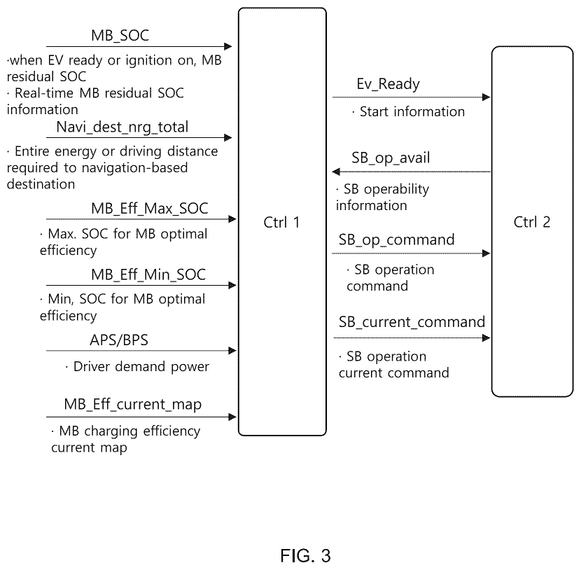

FIG. 3 illustrates information input to the first controller Ctrl1 and information exchange between the first controller Ctrl1 and the second controller Ctrl2.

As shown in FIG. 3, the first controller Ctrl1 may receive SoC information of the first high-voltage battery MB. For example, as the first mobility apparatus MLT1 starts, i.e., as a driver selects “EV Ready” of a start button, the SoC information may be transmitted from the BMS of the first high-voltage battery MB to the first controller Ctrl1. In this case, “EV Ready” may indicate a state in which power is supplied to the first drive motor M and driving is ready to be initiated.

The first controller Ctrl1 may also receive SoC information of the first high-voltage battery MB in real time while the first mobility apparatus MLT1 travels.

In addition, as a destination is determined, the first controller Ctrl1 may receive the electrical energy required to reach the destination or a driving distance (or mileage) to the destination, based on navigation device (e.g., an AVN device) information. For example, it is to be appreciated that the electrical energy required to reach the destination or the driving distance may be determined by a preset process in the first controller Ctrl1 based on the AVN information.

The first controller Ctrl1 may also receive, from the BMS or memory of the first high-voltage battery MB, a first SoC and a second SoC set for an optimal efficiency interval for charging/discharging the first high-voltage battery MB.

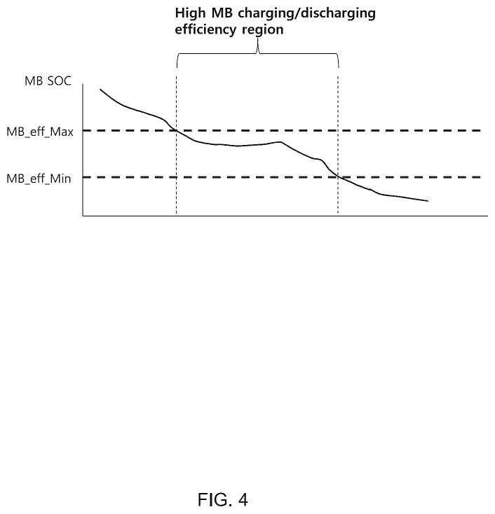

As shown in FIG. 4, the first SoC may be a lower set value (MB_eff_Min) of the optimal efficiency interval, and the second SoC may be an upper set value (MB_eff_Max) of the optimal efficiency interval.

The first controller Ctrl1 may also receive the APS and BPS information. The first controller Ctrl1 may determine a driver demand power, which is a power required by the driver, based on the APS and BPS information.

For example, as the driver presses an accelerator pedal, the APS information may be received by the first controller Ctrl1, a driver demand torque, which is a torque required by the driver, for the first drive motor M may be determined based on the APS information, and the demand power may be determined based on the demand torque.

The memory may store optimal charging current information according to a state of the first high-voltage battery MB for charging the first high-voltage battery MB.

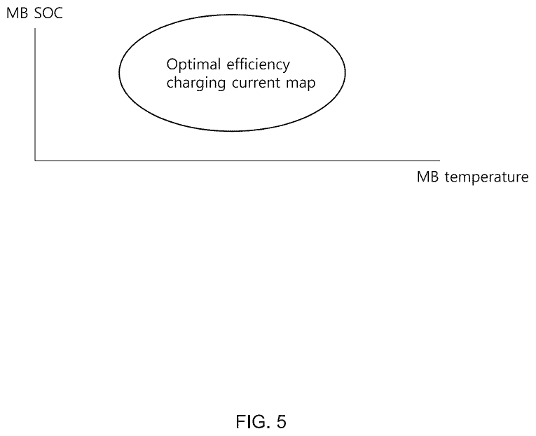

For example, as shown in FIG. 5, a charging current of the optimal charging efficiency, or an optimal charging efficiency current, for the first high-voltage battery MB may be determined based on an SoC and temperature state of the first high-voltage battery MB, and such optimal charging efficiency current map information may be stored in the memory in the form of a lookup table or a calculation equation. Based on such information, an optimal charging efficiency power according to the SoC and temperature state may be determined for the first high-voltage battery MB.

Meanwhile, the first controller Ctrl1 may transmit start state information of the first mobility apparatus MLT1 to the second controller Ctrl2. For example, the first controller Ctrl1 may transmit “EV Ready” information to the second controller Ctrl2. Through this, the second controller Ctrl2 may determine whether the first mobility apparatus MLT1 is in a state where it is ready to start traveling.

The first controller Ctrl1 may also transmit, to the second controller Ctrl2, an operation command (SB_op_command) of the second high-voltage battery SB and an output current-related command (SB_current_command).

Meanwhile, the second controller Ctrl2 may transmit operability information (SB_op_avail) of the second high-voltage battery SB to the first controller Ctrl1.

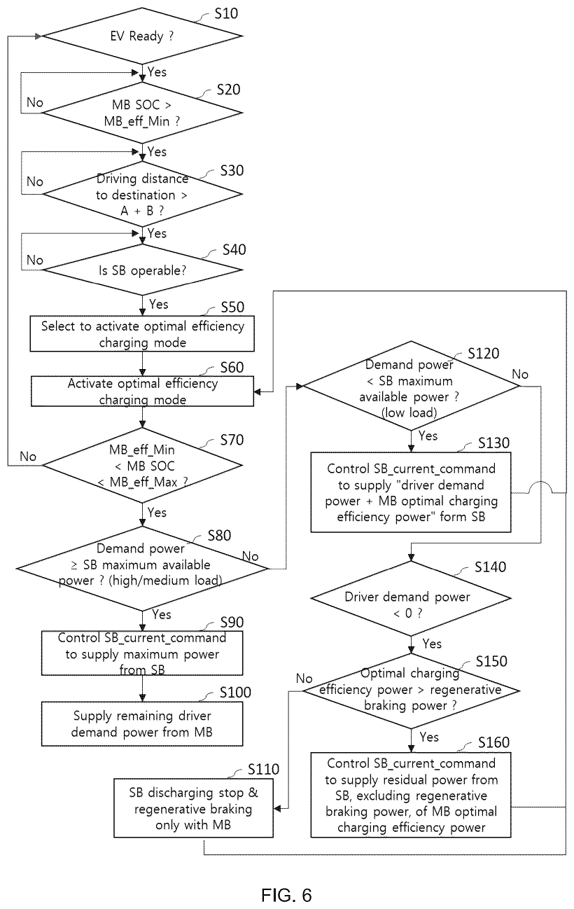

Hereinafter, a control process performed by the first controller Ctrl1 will be described in detail with reference to FIG. 6.

First, step S10 may be performed to check a start state of the first mobility apparatus MLT1.

The first controller Ctrl1 may check whether the first mobility apparatus MLT1 is in an “EV Ready” state based on information received from a start button of the first mobility apparatus MLT1.

Subsequently, in step S20, the first controller Ctrl1 may determine whether an SoC of the first high-voltage battery MB is greater than a set SoC.

In this case, the set SoC may be a first SoC, for example, a lower set value (MB_eff_Min) of an optimal efficiency interval.

Subsequently, in step S30, the first controller Ctrl1 may determine whether a driving distance to a destination is greater than a combined remaining driving distance of the first high-voltage battery MB and the second high-voltage battery SB.

In this case, when the driving distance to the destination is greater than the combined remaining driving distance, the first controller Ctrl1 may determine a plan for charging at a charging station and/or replacing the second high-voltage battery SB.

In this case, an SoC of the first high-voltage battery MB and/or the second high-voltage battery SB at a destination arrival time may be determined by an input from the driver, and the first controller Ctrl1 may determine this charging and replacement plan accordingly.

Subsequently, in step S40, the first controller Ctrl1 may determine whether the second high-voltage battery SB is operable. That is, for example, the first controller Ctrl1 may determine whether an operation of charging the first high-voltage battery MB by the second high-voltage battery SB is possible. In this case, whether the second high-voltage battery SB is operable may be determined by the first controller Ctrl1 as state information of the second high-voltage battery SB is received, or the second controller Ctrl2 may receive a result of the determination.

The operability of the second high-voltage battery SB may include whether the second high-voltage battery SB is capable of outputting a set range of a charging current in a set efficiency range based on a state of the second high-voltage battery SB.

In this case, the state of the second high-voltage battery SB may be determined based on battery conditioning information and/or the temperature and SoC of the second high-voltage battery SB.

For example, when it is determined in step S40 that the second high-voltage battery SB is capable of outputting an optimal charging current, a subsequent step may be performed.

In step S50, the first controller Ctrl1 may receive an input of an optimal efficiency charging mode selected by the driver.

To this end, although not shown, the first controller Ctrl1 may output a window for selecting the “optimal efficiency charging mode” via an AVN screen.

As the driver selects the optimal efficiency charging mode via the window, the first controller Ctrl1 may activate the optimal efficiency charging mode in step S60.

When the optimal efficiency charging mode is activated, the first controller Ctrl1 may perform charging of the first high-voltage battery MB by the second high-voltage battery SB according to the settings for the charging efficiency of the first high-voltage battery MB.

To this end, the first controller Ctrl1 may first determine whether the Soc of the first high-voltage battery MB is in a set range, i.e., between the first SoC and the second SoC.

For example, in step S70, the first controller Ctrl1 may determine whether the Soc of the first high-voltage battery MB is in the optimal efficiency interval between the lower set value (MB_eff_Min) and the upper set value (MB_eff_Max).

Subsequently, the first controller Ctrl1 may perform the charging of the first high-voltage battery MB by the second high-voltage battery SB according to the optimal charging efficiency power determined with respect to the charging efficiency based on the state (e.g., SoC and temperature) of the first high-voltage battery MB, and to the driver demand power. This will be described below.

First, the optimal charging current may be determined according to the charging current map information shown in FIG. 5, for example, and the optimal charging efficiency power may be determined based on the optimal charging current.

When it is determined in step S80 that the driver demand power is greater than or equal to a maximum available power of the second high-voltage battery SB (e.g., high/medium load), the first controller Ctrl1 may determine to charge the first high-voltage battery MB with the maximum power of the second high-voltage battery SB in step S90.

In this case, in step S100, the first controller Ctrl1 may allow the energy of the first high-voltage battery MB to be used as the remaining power.

For example, as the first high-voltage battery MB is charged with the maximum power of the second high-voltage battery SB in steps S90 and S100, the first high-voltage battery MB may output power corresponding to the driver demand power, satisfying a requirement by the driver.

In contrast, when it is determined in step S120 that the driver demand power is less than the maximum available power of the second high-voltage battery SB (e.g., low load), the first controller Ctrl1 may determine an output current such that the driver demand power and the charging power of the first high-voltage battery MB are supplied by the second high-voltage battery SB in step S130.

In this case, the charging power of the first high-voltage battery MB in step S130 may be determined based on the optimal charging efficiency power according to the charging current map information shown in FIG. 5. In this case, when the maximum available power of the second high-voltage battery SB is sufficient, the charging power may be determined as the optimal charging efficiency power according to the charging current map shown in FIG. 5, and otherwise it may be determined as a smaller value.

In contrast, when it is determined in step S140 that the driver demand power is less than zero (e.g., in the case of regenerative braking), the first controller Ctrl1 may determine whether the optimal charging efficiency power is greater than the regenerative braking power in step S150.

In this case, when it is determined in step S150 that the optimal charging efficiency power is greater than the regenerative braking power, the first controller Ctrl1 may determine an output current, i.e., a charging current, of the second high-voltage battery SB such that a power obtained by subtracting the regenerative braking power from the optimal charging efficiency power is supplied by the second high-voltage battery SB.

When it is determined in step S150 that the optimal charging efficiency power is not greater than the regenerative braking power, the first controller Ctrl1 may block the charging by the second high-voltage battery SB, that is, determine the output current (or the charging current) of the second high-voltage battery SB to be zero, in step S110. In this case, the first high-voltage battery MB may be charged only by the regenerative braking power. On the other hand, if it is determined in step S150 that the optimal charging efficiency power is greater than the regenerative braking power, then the first controller Ctrl1 may control the second high-voltage battery SB to supply the amount of power which is determined by subtracting the regenerative braking power from the optimal charging efficiency power, in step S160.

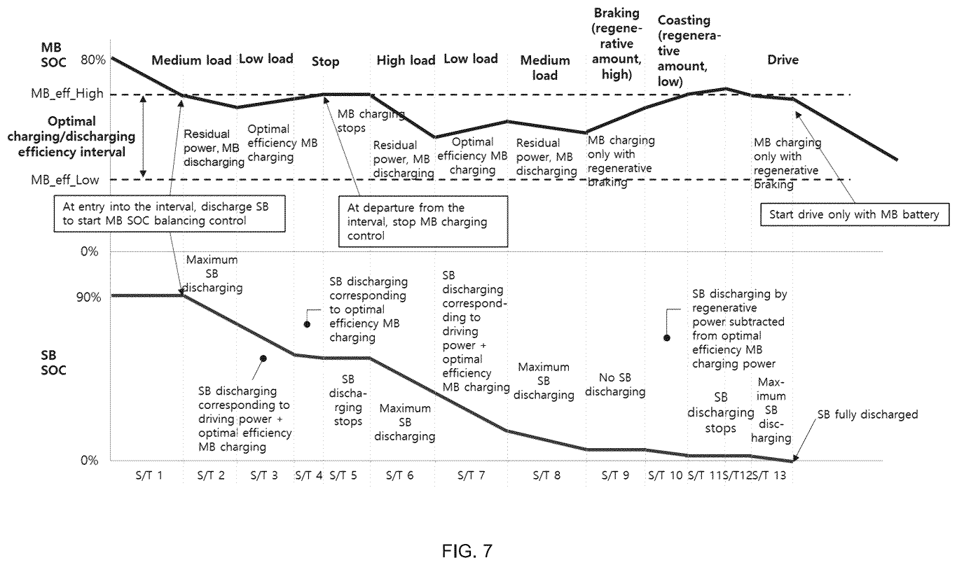

FIG. 7 illustrates charging of the first high-voltage battery MB for each interval during driving of a mobility apparatus, and SoC states of the first high-voltage battery MB and the second high-voltage battery SB according to an embodiment of the present disclosure, which will be described below.

For example, as shown, an SoC of the first high-voltage battery MB may be 80%, and an SoC of the second high-voltage battery SB may be 90%, at the start.

In a first section S/T1, which is a medium load section where the SoC of the first high-voltage battery MB is not within an optimal efficiency interval, charging the first high-voltage battery MB by the second high-voltage battery SB may not be performed. In the first section S/T1, the first high-voltage battery MB may only perform outputting without being charged, and accordingly its SoC may reach an upper set value (MB_eff_Max) of the optimal efficiency interval.

In a second section S/T2, the second high-voltage battery SB may be output at full power, but a driver demand power may be greater than that. Thus, the first high-voltage battery MB may be discharged as much as the power that is equal to one obtained by subtracting a maximum power of the second high-voltage battery SB from the driver demand power.

In a third section S/T3, which is a low load section where the driver demand power is less than a maximum available power of the second high-voltage battery SB, the second high-voltage battery SB may charge the first high-voltage battery MB while satisfying the driver demand power (driving power). That is, the power output from the second high-voltage battery SB may be used to charge the first high-voltage battery MB while covering the driver demand power.

In a fourth section S/T4 and a fifth section S/T5 where the first mobility apparatus MLT1 is at rest, the second high-voltage battery SB may charge the first high-voltage battery MB with the optimal charging efficiency power in the fourth section S/T4.

The first high-voltage battery MB may reach the upper set value (MB_eff_Max) of the optimal efficiency interval again in the fourth section S/T4, and the charging of the first high-voltage battery MB by the second high-voltage battery SB may be stopped in the fifth section S/T5. Therefore, in the fifth section S/T5, the SoCs of the first high-voltage battery MB and the second high-voltage battery SB may remain constant.

Subsequently, a sixth section S/T6 may be a high load section where the maximum available power of the second high-voltage battery SB is less than the driver demand power, and in this section, the second high-voltage battery SB may output its maximum power, and the first high-voltage battery MB may have an SoC that is reduced as much as the power that is equal to one obtained by subtracting the maximum power of the second high-voltage battery SB from the driver demand power.

In a seventh section S/T7, which is again the low load section, the second high-voltage battery SB may charge the first high-voltage battery MB with the optimal charging efficiency power while covering the driver demand power (driving power).

Subsequently, in an eighth section S/T8, which is the medium load section, the second high-voltage battery SB may output its maximum power, and the first high-voltage battery MB may have an SoC that is reduced as much as a power that is equal to one obtained by subtracting the maximum power of the second high-voltage battery SB from the driver demand power.

A ninth section S/T9 may be a section where the driver demand torque is less than zero, i.e., the driver presses a brake pedal to execute regenerative braking.

In the ninth section S/T9, because the regenerative braking power is greater than or equal to the optimal charging efficiency power of the first high-voltage battery MB by the second high-voltage battery SB, the discharging of the second high-voltage battery SB may be stopped, and the first high-voltage battery MB may be charged only with the regenerative braking power.

In a tenth section S/T10, which is a section corresponding to a coasting mode with a small regenerative braking power, the first high-voltage battery MB may be charged by the second high-voltage battery SB with a power that is equal to one obtained by subtracting the regenerative braking power from the optimal charging efficiency power of the first high-voltage battery MB.

In an eleventh section S/T11, which is a section where the SoC of the first high-voltage battery MB exceeds the upper set value (MB_eff_Max) of the optimal efficiency interval by the charging in the ninth section S/T9 and the tenth section S/T10, the charging by the second high-voltage battery SB may be stopped.

A twelfth section S/T12 may be a section where the SoC of the first high-voltage battery MB decreases again to the upper set value (MB_eff_Max) of the optimal efficiency interval while the charging by the second high-voltage battery SB is stopped.

A thirteenth section S/T13 may be a section where the second high-voltage battery SB reaches an SoC of a fully discharged state while charging the first high-voltage battery MB with its maximum output.

While the disclosure has been described in connection with certain embodiments, it will be understood that it is not intended to limit the invention to those particular embodiments. On the contrary, it is intended to cover all alternatives modifications, and equivalents included within the spirit and scope of the disclosure as defined by the appended claims.

1. A charging control method for a mobility apparatus comprising a plurality of first wheels, at least one first drive motor providing a driving power to the plurality of first wheels, a first high-voltage battery providing power to the at least one first drive motor, a first connection mechanism, and a first controller, the charging control method comprising:
charging the first high-voltage battery with a second high-voltage battery according to a setting for a charging efficiency of the first high-voltage battery;
wherein the second high-voltage battery is configured to be removeably connected to the first high-voltage battery to supply charging power to the first high-voltage battery while the mobility apparatus is traveling.

2. The charging control method of claim 1, wherein the setting comprises:
a determination of whether a state of charge (SoC) of the first high-voltage battery is within a set range.

3. The charging control method of claim 1, wherein the setting comprises:
a charging current determined with respect to the charging efficiency based on a state of the first high-voltage battery.

4. The charging control method of claim 3, wherein the state of the first high-voltage battery comprises:
an SoC and a temperature of the first high-voltage battery.

5. The charging control method of claim 4, wherein the charging current is further determined based on a driver demand power.

6. The charging control method of claim 5, wherein, when the driver demand power is less than an available power of the second high-voltage battery, the charging current is determined based on the driver demand power and an optimal charging efficiency power according to the SoC and the temperature of the first high-voltage battery.

7. The charging control method of claim 5, wherein, when the driver demand power is less than zero (0), the charging current is determined based on an optimal charging efficiency power according to the SoC and the temperature of the first high-voltage battery and a regenerative braking power.

8. The charging control method of claim 7, wherein, when the optimal charging efficiency power is greater than the regenerative braking power, the charging current is determined such that a power obtained by subtracting the regenerative braking power from the optimal charging efficiency power is output; and
when the optimal charging efficiency power is less than or equal to the regenerative braking power, the charging current is determined to be zero.

9. The charging control method of claim 7, wherein, when the driver demand power is greater than an available power of the second high-voltage battery, the charging current is determined such that a maximum power is output from the second high-voltage battery.

10. The charging control method of claim 1, wherein the charging comprises:
when an SoC of the first high-voltage battery is greater than a set first SoC, and a driving distance to a destination is greater than a combined remaining driving distance of the first high-voltage battery and the second high-voltage battery, receiving an optimal efficiency charging mode selected by a driver.

11. A mobility apparatus, comprising:
a plurality of first wheels;
at least one first drive motor configured to provide a driving power to the plurality of first wheels;
a first high-voltage battery configured to provide power to the at least one first drive motor;
a first connection mechanism; and
a first controller;
wherein a second high-voltage battery is removeably connected to the first high-voltage battery and configured to supply charging power to the first high-voltage battery while the mobility apparatus is traveling; and
wherein the first controller is configured to charge the first high-voltage battery with a second high-voltage battery according to a setting for a charging efficiency of the first high-voltage battery.

12. The mobility apparatus of claim 11, wherein the setting comprises:
a determination of whether a state of charge (SoC) of the first high-voltage battery is within a set range.

13. The mobility apparatus of claim 11, wherein the setting comprises:
a charging current determined with respect to the charging efficiency based on a state of the first high-voltage battery.

14. The mobility apparatus of claim 13, wherein the state of the first high-voltage battery comprises:
an SoC and a temperature of the first high-voltage battery.

15. The mobility apparatus of claim 14, wherein the charging current is further determined based on a driver demand power.

16. The mobility apparatus of claim 15, wherein, when the driver demand power is less than an available power of the second high-voltage battery, the charging current is determined based on the driver demand power and an optimal charging efficiency power according to the SoC and temperature of the first high-voltage battery.

17. The mobility apparatus of claim 15, wherein, when the driver demand power is less than zero (0), the charging current is determined based on a charging power determined according to the SoC and temperature of the first high-voltage battery and a regenerative braking power.

18. The mobility apparatus of claim 17, wherein, when the charging power is greater than the regenerative braking power, the charging current is determined such that a power obtained by subtracting the regenerative braking power from the charging power is output; and
when the charging power is less than or equal to the regenerative braking power, the charging current is determined to be zero.

19. The mobility apparatus of claim 17, wherein, when the driver demand power is greater than or equal to an available power of the second high-voltage battery, the charging current is determined such that a maximum power is output from the second high-voltage battery.

20. The mobility apparatus of claim 11, wherein the charging comprises:
when an SoC of the first high-voltage battery is greater than a set first SoC, and a driving distance to a destination is greater than a combined remaining driving distance of the first high-voltage battery and the second high-voltage battery, receiving an optimal efficiency charging mode selected by a driver.
